(19) United States
(12) Patent Application Publication
(10) Pub. No.: US 2007/0036371 A1
(43) Pub. Date: Feb. 15, 2007

(54) Method and apparatus for indexing and searching graphic elements

(75) Inventors: Vincentius Paulus Buil, Eindhoven (NL); Maurice Herman Johan Draaijer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/570,442

(22) PCT Filed: Aug. 23, 2004
(86) PCT No.: PCT/IB04/02753

§ 371 Date: Mar. 2, 2006

(30) Foreign Application Priority Data
Sep. 8, 2003 (EP) 03300111.6

(51) Int. Cl. H04R 25/00

(52) U.S. Cl. 381/312

(57) ABSTRACT

In an indexation method, an average color or a statistical distribution of colors in an image is determined by providing a set of coordinates in a multidimensional color space (80). The set of coordinates of each color is reduced to a level of Hue if the color verifies a first condition, i.e. the color is considered a true color (81), and to a level of Brightness if the color verifies a second condition, i.e. the color is considered a gray color (82). Indexation data for indexing the image includes the level of Hue or Brightness resulting from each color. The indexation method is used in a search method for searching a collection of graphic elements. An input specifies a desired color. A corresponding search query pertains to a level of Hue or a level of Brightness if the desired color includes a true color, or a gray color respectively.

### FIELD OF THE INVENTION

The present invention relates to an indexation method and apparatus for indexing a graphic element, a search method using an indexation method, a search apparatus for searching a collection of graphic elements, especially a collection of cover images which belong to respective information units, and a consumer electronics product comprising a search apparatus.

A cover image refers to an image that is specific to an information unit and that serves to identify the information unit. Information units comprising cover images include a great many types of goods, especially in a digital format, such as books, music albums, audio or video CDs, DVDs, movie posters, home videos, photos. The invention is applicable to searching any collection of images.

### BACKGROUND OF THE INVENTION

Accessibility of the data is a key feature in consumer electronics products that involve data storage. Research and experience have shown that some people remember colors more easily than names. People having that skill tend to search CDs by their cover colors instead of artist and/or album names, which they often do not remember. Until now, this type of search has been poorly supported in electronic tools for browsing large music collections.

WO-A-0221530 discloses an apparatus for reproducing an ordered information unit, such as a TV program. Starting from an ordered information unit, such as a video program, this apparatus generates a length display that encodes a specific description of the contents of the video frames, such as the average color, and allows content-driven navigation within the video program. The sequential order of the video frames is predetermined in the video program.

### OBJECT AND SUMMARY OF THE INVENTION

It is an object of the invention to facilitate indexing and searching of a collection of images or a collection of information units that people can identify by a cover image. It is another object of the invention to facilitate browsing through any type of information content that people would refer to by color.

Another object of the invention is to index graphic elements in accordance with their colors in a manner which corresponds to the way people generally refer to colors.

Another object of the invention is to create a search apparatus in which queries are formulated in a manner which corresponds to the way people generally refer to colors.

According to the invention, this object is achieved by an indexation method for indexing a graphic element, comprising the steps of determining a color attribute of the graphic element by providing a set of coordinates in a multidimensional color space for at least one color of the color attribute, reducing the set of coordinates of said at least one color to a level of Hue if said at least one color verifies a first condition, reducing the set of coordinates of said at least one color to a level of Brightness if said at least one color verifies a second condition, and storing indexation data for indexing said graphic element, said indexation data including a level of Hue resulting from said at least one color of the color attribute and/or a level of Brightness resulting from said at least one color of the color attribute.

A graphic element denotes any data comprising a specification of at least one color, including pictorial data, a digitized image or picture, a video frame, an icon, a portion of one of these elements, and the like. A color attribute denotes any feature of a graphic element which can be described by referring to a color or a plurality of colors, including an average color in the graphic element, a predominant color in the graphic element, a statistical distribution of colors in the graphic element, a color of the negative of the graphic element, and the like.

A basic idea of the invention is to condense the remarkable features of a graphic element in terms of colors in a small amount of indexation data by selecting the most relevant and significant type of indexation data with respect to the features which need to be represented by the indexation data. Another basic idea of the invention is that, from the point of view of a human observer, colors can be empirically divided into two classes. On the one hand, there are colors which can be located in the visible spectrum, i.e. among the colors of a rainbow, by a human observer. These are called true colors and are generally referred to by names, such as red, orange, etc. Although a color, which is clearly perceived as red, can be lighter or darker, this type of information can be considered secondary in comparison to the fact that the color is red. From the point of view of a human observer, the most significant or most easily memorized information about what is perceived as a true color is where it lies in the spectrum. Hence, for this first class of colors, the most significant indexation data is a parameter which characterizes precisely the position of the color in the visible spectrum, i.e. a level of Hue. The level of Hue refers to a parameter which is generally called by this name in conventional color systems such as Munsell, HSL, HSB and the like. On the other hand, there are colors, a human observer cannot locate in the visible spectrum, i.e. are perceived as being neither red, nor blue, etc. From a physical point a view, these colors result from a mix of wavelengths where the human eye does not perceive any predominance or from an insignificant overall luminosity. These colors include white, gray and black colors, and indefinite colors for which words are missing, and will be referred to as gray colors. From the point of view of a human observer, the most significant or most easily memorized information about that type of color is whether it is light or dark. Hence, for this second class of colors, the most significant indexation data is a parameter which characterizes precisely the luminosity, i.e. a level of Brightness. The level of Brightness refers to a parameter which characterizes the luminosity in conventional color systems such as Munsell, HSL, HSB and the like, and which is generally denoted “Brightness”, “Lightness”, “Luminance” or “value” in the art.

Thus, a color attribute of a graphic element is first determined by using a multidimensional representation of the color or colors of the color attribute. Such a multidimensional representation renders it possible to characterize and reproduce precisely any possible color or nuance. For example, some conventional computer systems can handle over 16 million colors. A number of conventional multidimensional representations of colors are known in the art, which can serve at this initial stage. Looking at existing color representations, there are always at least three colors parameters involved. Some well-known color representations, which are available in standard image treatment software applications such as Adobe PhotoShop 5.5, are:

Hue, Saturation, and Brightness (HSB)

Red, Green, and Blue (RGB)

Cyan, Magenta, Yellow, and blacK (CMYK).

The HSB system is preferred because this system is easy to understand and its parameters correspond to features which can be perceived by an observer looking at a color in most cases. The Hue represents a particular position in the color spectrum. Saturation represents how deep the color is, i.e., whether it is a full color or a pastel shade. Finally, Brightness determines whether it is a light or a dark color.

Then, a reduced representation of the color can be generated, which is stored as indexation data for the graphic element. The reduced representation is a level of Hue if a first condition is verified and a level of Brightness if a second condition is verified. The first condition should preferably match the above first class of colors and the second condition should preferably match the above second class of colors. Thus, the multidimensional representation of the color is converted into a single parameter. The first and the second condition can be designed so as to map or project the entire color space onto a Hue axis and a Brightness axis. In a preferred embodiment, this projection can be designed such that each point in the color space corresponds to one and only one level of Hue or Brightness. Moreover, a Hue axis and a Brightness axis can be integrated into a single composite axis, so as to project the entire color space onto a single axis, which represents a significant information about each and every color. Such a composite axis can be used to sort all the colors into a single list and to order the colors in a visually significant manner.

Conversion techniques are known in the art for converting the representation of a color from one color space to another. These techniques may be used for computing a level of Hue or a level of Brightness from a set of coordinates in any conventional color space. Obviously, the computation is minimal when starting from the HSB color space. The resulting indexation data has the advantage that it is both short and significant, so that it can serve to sort or retrieve graphic elements efficiently.

The measure as defined in claim 2 has the advantage that predefined regions of the color space may be designed so as to embody the first and second empirical classes of colors defined above with a satisfying level of accuracy. The mapping of these empirical classes onto regions of the color space is especially simple when using the HSB color space. However, more complex conditions can also be used, so as to take into account more than the own properties of the color, for example the colors of adjacent pixels.

The measure as defined in claim 3 provides a simple and generally acceptable definition of the colors, which are generally perceived as true colors. The remaining part of the color space is advantageously considered as colors of the second empirical class.

The measure as defined in claim 4 has the advantage that the indexation data generated characterizes the distribution of colors in the graphic element in a condensed format. For example, the indexation data may take the form of a composite color histogram, where each pixel is counted either as a gray color or as a true color. Such an histogram can be represented in one dimension.

The measure as defined in claim 5 has the advantage that the spectrum of Hue and the spectrum of Brightness can be segmented in accordance with generic types of colors, i.e. groups of colors which are given a usual name, such as Red, Yellow, Green, Black, White, etc. Hence, the selection of the indexation data from the group consisting of Hue and Brightness combined with the predefined segmentation of the spectrums of Hue and Brightness allows to map or project the entire color space onto a single set of generic language-based categories of colors. In a preferred embodiment, this projection can be designed such that each point in the color space projects onto one and only one generic category. With the indexation data sorted in accordance with claim 5, simple and efficient search methods can be implemented, in which a query corresponds to usual terms of language, and in which graphic elements are retrieved in response to such a query by simply looking into the proper categories without the need to translate the query into more complicated abstract data.

The measure as defined in claim 6 has the advantage that a collection of graphic elements can be sorted into a list or an array, which can serve for a subsequent retrieval and ranking of graphic elements. For example, the color attribute may be an average color of the graphic element or a predominant color in the graphic element. The graphic elements can be sorted in accordance with the single color into an array having rows and columns, in which each row or each column consists of graphic elements whose indexation data falls into a predefined segment of Hue or Brightness. When the indexation data is used in a search method, the results of the search can be displayed in accordance with the sorting of the indexation data. Since the indexation data can be sorted prior to inputting the query, no substantial computation is involved at the time of the retrieval. This sorting has a visual meaning since the order of the graphic elements in the list or the order of the rows or the order of the columns in the array corresponds to increasing or decreasing levels of Hue or Brightness. Hence, the retrieval of graphic elements on the basis of a desired color can be performed easily and quickly by selecting a matching portion of the matching subset.

The invention also provides a search method using the above indexation method for searching a collection of graphic elements, said search method comprising the steps of indexing each graphic element of the collection with said indexation method, receiving at least one input specifying at least one desired color, determining a search query corresponding to said at least one input, said search query pertaining to a level or range of Hue if said at least one desired color includes a true color and to a level or range of Brightness if said at least one desired color includes a gray color, analyzing the indexation data of the graphic elements for selecting graphic elements whose indexation data comprises at least one level of Hue or Brightness substantially matching the search query, and retrieving the selected graphic elements from the collection.

With this search method, one can search a collection of graphic elements or information units including graphic elements with only visual information in mind rather than titles or numbers or other alphanumerical information. The search process can be quickly performed since time-consuming computations involved in indexing the graphic elements, such as the evaluation of statistical distribution of colors in color images, are carried out prior to the search and need not be repeated for each query, and since the indexation data itself is more condensed. Further, since the query is based on the specification of one or several desired colors, the user interface for inputting a query can be made simple and user-friendly.

The measure as defined in claim 8 has the advantage that the query formulation is made very intuitive because the user can rely on similarities between the colors of the colored portions in the color scale and the colors in the desired image in order to select the most similar colored portion.

The colored portions may correspond to generic types of colors, such as green, blue, red, yellow, black, white, etc. Thus, the user interface can be made very simple. In an alternative embodiment, the colored portions are defined as a function of a distribution of the levels of Hue or Brightness among the indexation data of the graphic elements. This has the advantage that the color of a colored portion can be rendered very similar to the average or predominant colors that can be found in the indexed graphic elements.

The measure as defined in claim 9 has the advantage that the marker can operate as a filter to select a predefined range of Hue or Brightness. When a small number of positions are provided, pre-computations can be carried out with the indexation data so as to speed up the subsequent retrieval of graphic elements. The marker may be of any form, such as an arrow or a square window overlaid on the composite color scale. In another particular embodiment, the marker is allowed to move continuously along the color scale. This makes for a smooth movement of the marker, so as to select precisely any color shown on the composite color scale.

Thanks to the measure as defined in claim 10, the design of the composite color scale gives an overview of the distribution of the graphic elements in terms of their respective single color attributes. Hence, the length of a colored portion in a color scale is proportional to the number of graphic elements, whose corresponding indexation data falls into a given range represented by the colored portion. To do this, it is possible to adapt the respective ranges corresponding to the colored portions and/or the lengths of the colored portions to the collection of graphic elements. For example, each colored portion may be of the same length and the corresponding range can be defined so as to associate a substantially equal number of graphic elements with each colored portion, in terms of their single color attributes. A further advantage is that the color scale includes only colored portions whose corresponding levels or ranges of Brightness or Hue one matched by the indexation data of at least one graphic element. Thus, all the portions of the composite color scale are useful and a size of the composite color scale on a display is optimized.

The invention also provides an indexation apparatus for indexing a graphic element, comprising a color analyzer for determining a color attribute of the graphic element by providing a set of coordinates in a multidimensional color space for at least one color of the color attribute, for reducing the set of coordinates of said at least one color to a level of Hue if said at least one color verifies a first condition, and for reducing the set of coordinates of said at least one color to a level of Brightness if said at least one color verifies a second condition, and storage means for storing indexation data for indexing said graphic element, said indexation data including a level of Hue resulting from said at least one color of the color attribute and/or a level of Brightness resulting from said at least one color of the color attribute.

The invention also provide a search apparatus for searching a collection of graphic elements, comprising:
an indexation apparatus as defined above for indexing each graphic element of the collection,
a user-operable input means for receiving at least one input specifying at least one desired color and for determining a search query corresponding to said at least one input, said search query pertaining to a level or range of Hue if said at least one desired color includes a true color and to a level or range of Brightness if said at least one desired color includes a gray color,
a graphic element retrieval controller for analyzing the indexation data of the graphic elements so as to select graphic elements whose indexation data comprises at least one level of Hue or Brightness substantially matching the search query, and for retrieving the selected graphic elements from the collection.

The invention also provides a consumer electronics product involving data storage and comprising a search apparatus as defined above. By way of example, such a consumer electronic product may be a mobile phone, an audio and/or video player, a laptop, a Set-Top-Box, etc.

These and other aspects of the invention will be apparent from and elucidated with reference to the embodiments described hereinafter, by way of example, with reference to the drawings.

### BRIEF DESCRIPTION OF THE DRAWINGS

FIG. 1 is a diagrammatic representation of an image search apparatus in accordance with an embodiment of the invention,

FIG. 2 shows a flowchart of a search method in accordance with a general embodiment of the invention,

FIG. 3 shows a user-interface screen for use in the search method in accordance with a first embodiment of the invention,

FIG. 4 shows a user-interface screen for use in the search method in accordance with a second embodiment of the invention,

FIG. 5 shows a method of computing a score for ranking the retrieved images in the search method of FIG. 4,

FIG. 6 shows a user-interface screen for use in the search method in accordance with a third embodiment of the invention,

FIG. 7 shows a user-interface screen for use in the search method in accordance with a fourth embodiment of the invention,

FIG. 8 is a cross-sectional graph of the HSB-color space showing two predefined regions used in indexation methods in accordance with embodiments of the invention,

FIG. 9 shows a composite color histogram for the indexation of an image in accordance with embodiments of the invention,

FIG. 10 shows a segmented composite color histogram for the indexation of an image in accordance with embodiments of the invention.

### DETAILED DESCRIPTION OF THE INVENTION

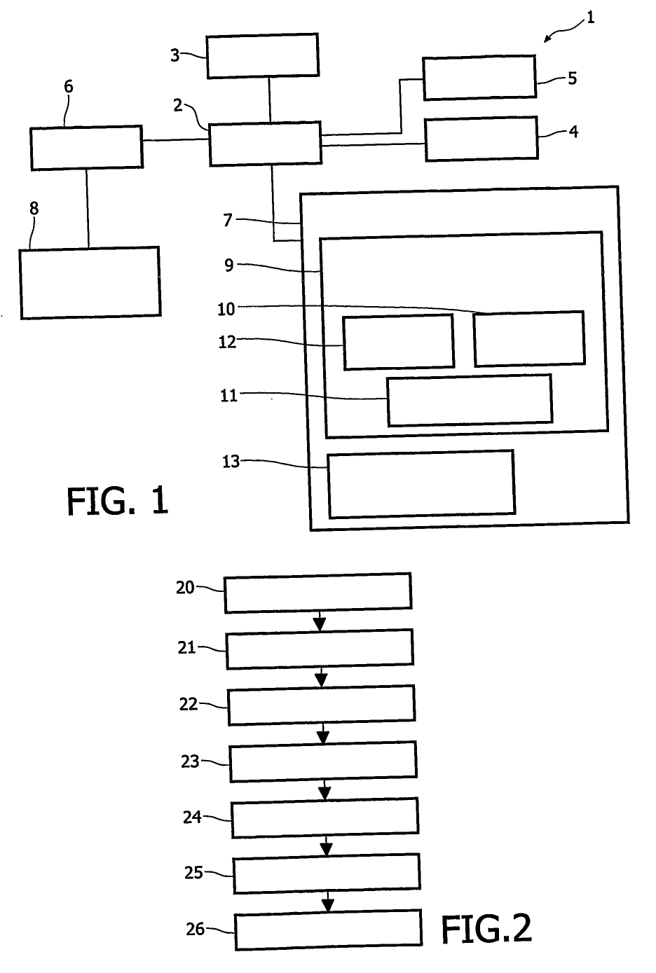

FIG. 1 shows one embodiment of a computer system suitable for implementing the indexation and search methods of the present invention. The image search system 1 includes a processor 2 operatively coupled to a display 3, a pointing device 4, such as a mouse or other, a keyboard 5, a mass storage device 6 and an addressable memory 7. The mass storage device 6 is for permanently storing images including graphic images and digitized photographs. In the mass storage device 6, the images may be stored in an information units database 8, where an information unit may be the image itself or a more complex object which includes the image. In an embodiment of the invention, the information units database 8 is a music album database where each information unit includes the following fields: album title, artist's name, audio tracks (in any appropriate audio file format, for example MP3) and cover image (in any appropriate image file format, for example JPEG). The cover image field contains a digital image of the album cover.

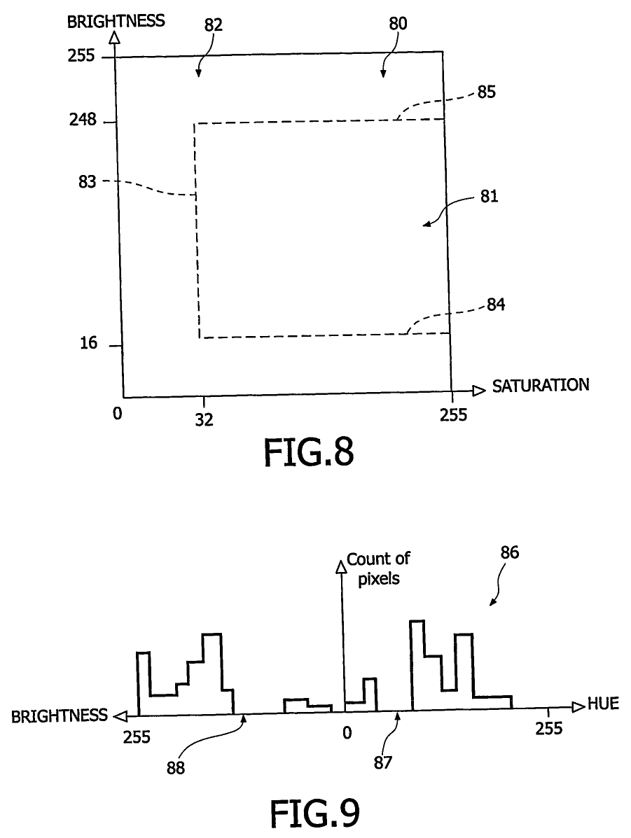

The memory 7 stores a software application 9 that controls the processor 2 for effecting the image indexation methods to be described with reference to FIGS. 8 to 10 and the image search methods to be described with reference to FIGS. 2 to 7. These image search methods enable a user to interact with the computer system so as to retrieve and display one or several images which have certain color attributes. The image search software application 9 includes an image analyzer 12 that analyzes the images in the database 8 and creates image indexation files 13 that contain image indexation data related to the images. The image indexation files 13 may be stored with the images or separately. The user interface controller 11 provides a user interface screen on the display 3 and monitors inputs from the pointing device 4 and keyboard 5 for elaborating search queries in the user interface. The search query is passed on to the image retrieval and display controller 10, which retrieves images matching the query and displays them on the display 3. The display 3 is of conventional design and should have sufficient spatial and color resolution for displaying the images provided by the image retrieval and display controller 10.

Referring now to FIGS. 8 to 10, several indexation methods are described which are implemented by the image analyzer 12 for generating the image indexation files 13.

According to a first embodiment, the indexation of each image is based on the average color. Accordingly, the following steps are carried out:
a) The colors of each pixel in an image are computed in terms of Hue, Saturation and Brightness coordinates. The average Hue, average Saturation and average Brightness are calculated in the image. The average Hue is calculated by adding up the levels of Hue of all pixels and dividing this sum by the number of pixels. Average Saturation and average Brightness can be similarly calculated.
b) FIG. 8 represents a cross section of the HSB-color space taken on a plane of constant Hue and shows a segmentation of the HSB-color space 80 into two predefined regions 81 and 82. This segmentation serves to characterize the average color with respect to how a human observer would generally perceive and describe it. In FIG. 8, the region 81 includes the colors which are generally perceived as true colors, i.e. the colors of a rainbow (visible spectrum of electromagnetic waves). The region 82, which encompasses the remaining portion of the color space 80, includes colors which are generally perceived as gray colors, i.e. all the colors which are not closely related to the colors of a rainbow, including white, gray and black.

The region 81 has a lower Saturation boundary 83. Indeed, when the average Saturation of the image is very low, the average Hue has little relevance with respect to what an observer looking at the image would perceive. If the Saturation is exactly zero, which is the case with black-and-white images, the Hue is meaningless. In that case, the average color in the image is substantially a gray color for a human observer, so that it can be completely determined by the average level of Brightness regardless of the level of Hue. For example, the lower Saturation boundary can be selected between 10 and 25%. In the preferred embodiment shown on FIG. 8, the lower Saturation boundary is 32 on a 0-255 scale.

The region 81 has a lower Brightness bound 84. Indeed, when the Brightness is close to zero or zero, the average color in the image is perceived as almost black or black, regardless of the levels of Hue and Saturation. For example, the lower Brightness bound may be selected between 5 and 25% or lower. In the preferred embodiment shown in FIG. 8, the lower Brightness bound is 16 on a 0-255 scale.

The region 81 also has an upper Brightness bound 85. Indeed, when the Brightness is close to a minimum or a maximum, the average color in the image is perceived as almost white or white, regardless of the levels of Hue and Saturation. For example, the upper bound may be selected between 75 and 95%. In the preferred embodiment shown in FIG. 8, the upper Brightness bound is 248 on a 0-255 scale.

c) If the average color belongs to region 81, only the level of Hue of the average color is stored as indexation data of the image in the indexation files 13. If the average color belongs to region 82, only the level of Brightness of the average color is stored as indexation data of the image in the indexation files 13.

Hence, a single indexation data is obtained for every image in the database 8. This single indexation data may serve to sort the images in a visually significant manner, for example in a single list, and to retrieve images in a simple way.

According to a second embodiment, the indexation of each image is based on the statistical distribution of colors. Accordingly, the following steps are carried out:

a) The colors of each pixel of an image are computed in terms of Hue, Saturation and Brightness coordinates.

b) For each pixel of the image, it is determined whether the pixel belongs to region 81 or to region 82 defined above.

c) As shown in FIG. 9, a composite color histogram 86 of the image is generated, which includes a half-axis 87 representing the full spectrum of Hue and a half-axis 88 representing the full spectrum of Brightness. For example, the level of Hue and the level of Brightness are expressed as 1-Byte integers between 0 and 255. The pixels belonging to region 81 are counted in vertical bars on the half-axis 87, regardless of the levels of Brightness and Saturation. The pixels belonging to region 82 are counted in vertical bars on the half-axis 88, regardless of the levels of Hue and Saturation.

d) The composite color histogram 86 is stored as indexation data of the image in the indexation files 13. The composite color histogram 86 has the advantage that it represents all the colors in the image on a single horizontal axis. It may serve to sort the colors according to their prevalence in the image. The resolution of the half-axes 87 and 88 should not be too high so as not to dilute the significant patterns of the distribution of colors. The histogram shown in FIG. 9 has arbitrary counts of pixels for a purely illustrative purpose.

According to a third embodiment, the distribution of colors in the image is sorted in accordance with predefined generic types of colors. Accordingly, the spectrum of Hue is segmented into six predefined segments of Hue which correspond to the following generic types of true colors: Red, Orange, Yellow, Green, Blue and Purple. The definition of these segments is summarized in Table 1. The spectrum of Brightness is segmented into three predefined segments of Brightness which correspond to the following generic types of gray colors: White, Gray and Black. The definition of these segments is summarized in Table 1.

TABLE 1
B denotes the level of Brightness and H denotes the level of Hue.
All levels measured on a 0-255 scale.

| Generic Color Type | Definition |
|---|---|
| WHITE | B > 196 |
| GRAY | 64 ≦ B ≦ 196 |
| BLACK | B < 64 |
| RED | H < 16 OR H ≧ 240 |
| ORANGE | 16 ≦ H < 32 |
| YELLOW | 32 ≦ H < 48 |
| GREEN | 48 ≦ H < 112 |
| BLUE | 112 ≦ H < 188 |
| PURPLE | 188 ≦ H < 240 |

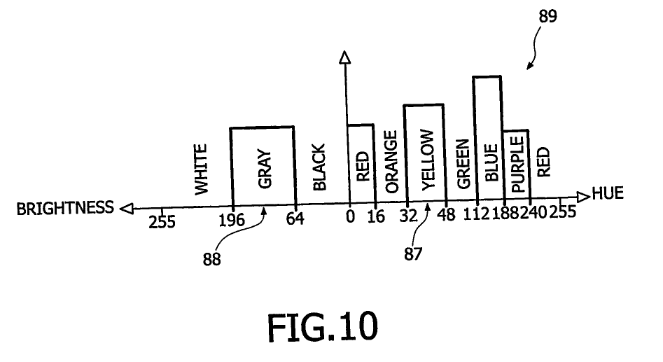

In the third embodiment, a composite color histogram is generated in a similar manner as in the second embodiment. However, as shown in FIG. 10, the resolution of the half-axes 87 and 88 matches the predefined segments. Hence, the composite color histogram has three counts (or bars) for the pixels belonging to region 82 of the color space and seven counts (or bars) for the pixels belonging to region 81 of the color space. It should be noted that the generic Red type includes two bars. In a modification not shown, the half-axis 87 may be modified so as to merge the two bars corresponding to the generic Red type. The segmented composite color histogram 89 shown on FIG. 10 has arbitrary counts of pixels for a purely illustrative purpose. The segmented composite color histogram 89 has the advantage that the statistical distribution of colors represented by computational parameters is mapped onto a single set of categories, which match the usual categories and terms with which people describe colors in a simple way. The segmented composite color histogram 89 can be stored as indexation data of the image in the indexation files 13.

According to a fourth embodiment of the indexation method, a segmented composite color histogram 89 is generated as mentioned above and a predominant generic type of color is determined by selecting the segment having the highest count of pixels in the segmented composite color histogram 89. Instead of storing the entire histogram in the indexation files 13, the image can be indexed with only the predominant generic type of color and the count or proportion of pixels falling into the corresponding segment. Again, this simple indexation data may serve to sort the images in a visually significant manner, for example in a matrix, and to retrieve images in a simple way.

Quantitative limits have been proposed in order to distinguish when a color should be generally perceived as a true color and when it should be generally perceived as a black and white color, i.e. a level of gray. Since this distinction is a matter of psychological perception, other quantitative limits may be used. Moreover, the above quantitative limits, which have been applied in the color system used in the software application PowerPoint® by Microsoft®, may be modified and tuned in accordance with the monitor, the graphics card and all the software and hardware components of the computer system which have an influence on the reproduction of colors. The same applies to the quantitative limits, proposed to delineate the generic types of colors.

It should be noted that drawing a clear-cut limit between true colors and gray colors is a matter of subjective perception, which different persons may solve differently. For example, a very pale color will be perceived as a true color by one person and as white by another person. For this reason, in a modified embodiment, a region of transition can be defined in which a color verifies both the condition for indexation with a level of Hue and the condition for indexation with a level of Brightness. In that embodiment, pixels falling into this region of transition are counted in both parts of the composite color histogram. Thus, of two images having the same distribution of Hue, that which has paler colors will have a higher number of pixels in the histogram portion related to the gray scale. For example, the transition region (not shown) takes the form of a U-shaped band centered on the boundaries 83, 84 and 85 shown in FIG. 8 and overhanging on both sides of them.

FIG. 2 is a flowchart which represents an overview of an image search method in accordance with a general embodiment of the invention. First, in the image input step 20, a number of images are input into the image search system 1 and stored in the information units database 8 for use during the search process. For example, the images are input into the information units database 8 by digitizing them with a digitizer, by composing them in conventional graphic design applications, or by downloading them from another device, such as a remote computer or a digital camera. As mentioned, the images may be part of more complex data structures, such as digitized music albums. The images may be compressed by conventional compression techniques in order to reduce their storage requirements. In the image analysis step 21, the image analyzer 12 analyzes each image in order to generate indexation data which is stored in the image indexation files 13. In the optional image sorting step 22, the image analyzer 12 uses the indexation data of the images in order to sort the images as a function of their color attributes, so that a subsequent retrieval of the images will be speeded up. In the user interface screen generation step 23, the user interface controller 11 generates a user interface screen which is displayed on the display 3. In the query input step 24, the user inputs a querying to the image search apparatus with the pointing device 4 or the keyboard 5 and the user interface screen. In the image retrieval step 25, the image retrieval and display controller 10 uses the indexation data to retrieve images from the database 8 which substantially match the query. As an option, a score for ranking each retrieved image may be computed. In the image display step 26, the retrieved images are displayed on the display 3 for further identification by a human observer.

Detailed embodiments of the search method will be described below.

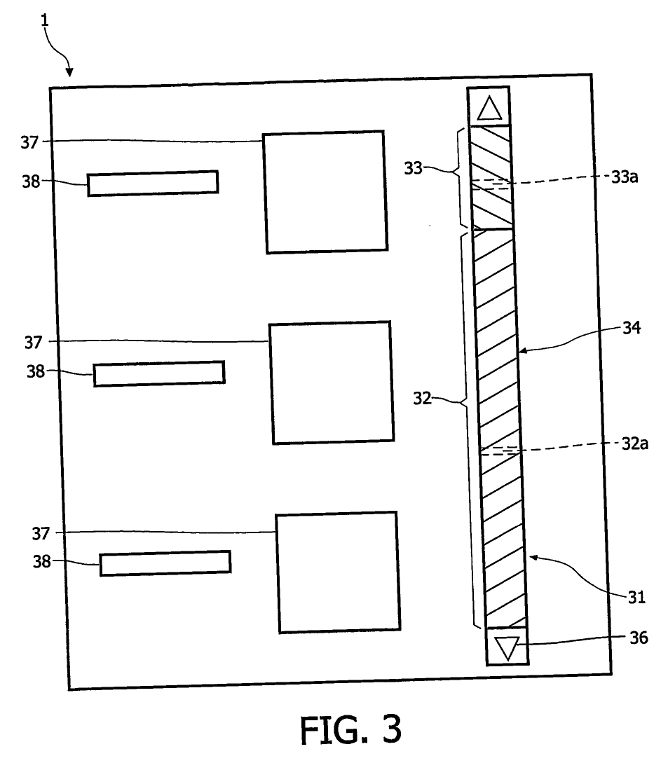

In the first embodiment, the indexation and search of the images is based on the average color. A corresponding user interface screen 30 for elaborating a query and visualizing the retrieved images is shown in FIG. 3.

In the image analysis step 21, the image analyzer 12 analyzes each image in accordance with the first embodiment of the indexation method. A level of Brightness or a level of Hue related to the average color in the image is stored in the indexation files 13.

In the image sorting step 22, the image analyzer 12 sorts the images into two subsets according to indexation data, i.e. images whose indexation data is a level of Hue are sorted into a first subset and images whose indexation data is a level of Brightness are sorted into a second subset. In each subset, the images are ranked in a list according to the level of their respective indexation data, for example in increasing or decreasing order. A collection index describing the composition and inner order of each subset is stored in the image indexation files 13.

In the user interface screen generation step 23, the user interface controller generates a composite color slider bar 31 to be displayed in the user interface screen 30. The composite color slider bar 31 consists of a true color scale 32 for the input of queries pertaining to the level of Hue, a gray color scale 33 for the input of queries pertaining to the level of Brightness, a cursor 34 which is movable along true color scale 32 and gray color scale 33, and control buttons 35 and 36 for moving the cursor 34 up and down, respectively.

The true color scale 32 is a straight band which represents the color spectrum in a gradual manner, possibly with some gaps. The true color scale 32 is composed of adjacent homogeneous colored portions 32a. Each portion 32a has a true color, which has a respective level of Hue. The portions 32a are ordered according to the level of Hue, for example increasing in upward and decreasing in downwards direction, or the other way around. Thus, the true color scale 32 looks similar to a rainbow.

In the first embodiment, the true color scale 32 is generated, for example, according to the following steps:

(a) A preset length of the true color scale 32 in terms of number of pixels on the display 3, say L, is divided by the number of images in the first subset, say N. The number R=L/N represents the length of the color scale per image.

(b) If the number R is greater than 1, one colored portion 32a will be generated for each image, said colored portion having a level of Hue equal to that in the corresponding indexation data.

(c) If the number R is smaller than 1, each colored portion 32a will match several images from the first subset. For example, the colored portions 32a are generated with a length of one pixel. The first subset of ranked images is sequentially segmented into groups including [1/R] or [1/R]+1 images each. One colored portion 32a is generated for each said group and is given a color having a level of Hue which results from the indexation data of the images in the group. For example, the level of Hue of the colored portion 32a may be calculated as the average value or the highest value or the lowest value of the indexation data of the images in the group. However, since only the indexation data is used, the average saturation and average brightness of the images in the first subset are not taken into account for the generation of the true color scale 32. Brightness and Saturation throughout the true color scale 32 should be set with a view to avoiding any ambiguity as to what color is shown in each colored portion. For example, Saturation may be set in the upper part of the corresponding spectrum and Brightness may be set in the middle of the corresponding spectrum.

The true color scale 32 generated in the above-mentioned manner gives an overview of the collection of images in the first subset, ensures a substantially even distribution of images along the true color scale 32, and will allow a smooth scrolling of the list of retrieved images when the cursor 34 is moved along the true color scale 32. Parts of the color spectrum which are matched by none of the images in the first subset are not represented. Hence, the true color scale 32 may comprise some abrupt transitions in terms of Hue.

In the above true color scale generation method, a minimum length is allocated to each colored portion so as to obtain the finest possible resolution in terms of colors which are offered for the user to select a desired color. However, colored portions 32a having a length of more than one pixel may be constructed in a similar manner.

The gray color scale 33 is a straight band which represents the gray spectrum in a gradual manner, from white to black, possibly with some gaps. The gray color scale 33 is composed of adjacent homogeneous gray-colored portions 33a. Each portion 33a has a gray color, which has a respective level of Brightness and zero Saturation. The portions 33a are sorted according to the level of Brightness, for example increasing in upward and decreasing in downward direction, or the other way around. The gray color scale 33 is generated in the same way as the true color scale 32, so the reader is referred to the above description of the true color scale generation, substituting the second subset of images for the first subset of images and the level of Brightness parameter for the level of Hue.

In the query input step 24, the user inputs a querying to the image search system with the pointing device 4 or the keyboard 5 by placing the cursor 34 at a certain position along the composite color slider bar 31. The user only needs to pay attention to the appearance of the colored portions 32a and 33a in order to select a colored portion 32a or 33a which best represents the average color in the desired image. More precisely, placing the cursor 34 at a position along a colored portion 32a of the true color scale 32 creates a query pertaining to Hue referring to the level of Hue of the color of said portion 32a. Placing the cursor 34 at a position along a colored portion 33a of the gray color scale 33 creates a query pertaining to Brightness and referring to the level of Brightness of the color of said portion 33a. Accordingly, the query comprises no other information than a level of Brightness or a level of Hue in the first embodiment. From the point of view of the user, the query is only a desired true or gray color.

In the image retrieval step 25, the image retrieval and display controller 10 retrieves one or more images in the database 8 which will best match the query. Using the collection index obtained in step 22 and stored in the indexation files 13, the image retrieval and display controller 10 only has to jump to the appropriate sequential position in the list of ranked images in the appropriate subset, i.e. to the image indexation data, which best matches the query, and to retrieve the corresponding image identification code or address, as well as those of a certain number of adjacent images in the list, say M. Then the M images are retrieved from the database 8. All this requires no substantial computation as the ranking of the images has already been written in the collection index.

As is visible in FIG. 3, in the image display step 26, the retrieved images 37 are displayed in the form of a one-dimensional list parallel to the composite color slider bar 31 in the sequential order which corresponds to the orientation of the corresponding color scale 32 or 33 with respect to changes in the average color. If the cursor 34 is moved at the transition between color scales 32 and 33, the images at an end of the first subset are displayed adjacent to the images at the end of the second subset, so that a continuous list is displayed for any position of the cursor 34. The gray color scale 33 may be located above or below the true color scale 32.

In the example shown in FIG. 3, M=3, i.e. three images 37 are displayed. Each image 37 represents the cover of a music album. The title and artist's name of the album are also retrieved from the database 8 and displayed at 38 adjacent to the corresponding image 37. The number M of images to be displayed simultaneously may be preset or user-defined. A zoom-in button and a zoom-out button (not shown) may be provided for selecting the number of images, to be simultaneously displayed, i.e. the portion of the list.

Hence, CD covers that have an average true color are ordered by their average level of Hue, regardless of Saturation and Brightness. These values will still vary in the Hue-ordered list of CD covers. CD covers that do not have an average true color, i.e. whose average level of Saturation is low and/or whose average level of Brightness is very high or very low, are ordered by their average level of Brightness, regardless of the exact levels of Saturation and Hue. All CD/MP3 album covers are ordered on the basis of their average color and displayed in a one-dimensional list, which can be navigated through by means of the slider bar 31. This slider bar shows the colors of the covers in a condensed format to enable quick jumping to the section of the desired CD cover.

It has been found that there are cases in which the average level of Hue may be meaningless although the average color of the image belongs to the region 81. For example, this may occur when the image includes many different colors or an equal distribution of a limited set of colors. It is also sensible in these cases to index these images with the average level of Brightness instead of Hue. Hence, the rules for deciding that an image should be indexed with the level of Hue or the level of Brightness may be based on more complex conditions than just the location of the average color with respect to the regions of the color space. These more complex conditions will then take into account the distribution of colors in the image in order to detect the images where many different colors or an equal distribution of a limited set of colors are present. Such conditions can be refined via user testing.

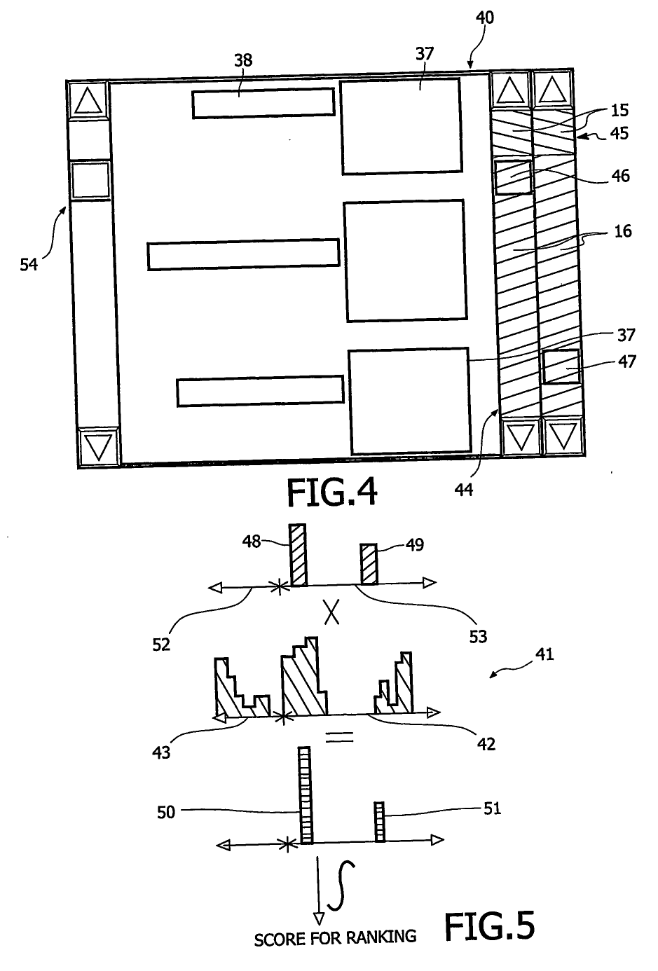

A second embodiment of the search method will be described below with reference to FIG. 4.

In the second embodiment, the image analysis step 21 is carried out in accordance with the second embodiment of the indexation method as described above. The image sorting step 22 is omitted in the second embodiment.

As is visible in FIG. 4, the user-interface screen 40 of the second embodiment has two identical composite color slider bars 44 and 45, which look similar to the composite color slider bar 31 of the first embodiment. In the composite color slider bars 44 and 45 however, the gray scale 15 is a predefined scale which spans the entire spectrum of Brightness from black to white, regardless of the actual distribution of colors in the images. Likewise, the true color scale 16 is a predefined scale which spans the entire spectrum of Hue, regardless of the actual distribution of colors in the images. The markers 46 and 47 have the form of square windows which span a portion of the color scales on both composite color slider bars 44 and 45.

In the query input step 24, a query is input on the basis of the position of the two markers 46 and 47. Each marker operates as a running filter, as will be explained with reference to FIG. 5.

The upper graph in FIG. 5 is a schematic representation of a search query corresponding to the position of the markers 46 and 47 In FIG. 4. The query is represented as a set of two filters 48 and 49 located on a composite axis which comprises a portion 52 representing the gray color scale 15 and a portion 53 representing the true color scale 16. The positions of the markers 46 and 47 on the composite color slider bars 44 and 45 determine the positions of the filters 48 and 49, respectively. The filters 48 and 49 are represented as square filters, with the total weight of filter 48 being larger than the total weight of filter 49. However, the filters 48 and 49 may be given a different shape such as, for example, an acute shape, to obtain more selectivity.

In FIG. 5, the intermediate graph represents the composite color histogram 41 of an image, in which the portion 43 relates to the spectrum of Brightness and portion 42 relates to the spectrum of Hue. A similar histogram corresponding to each image is stored in the indexation files 13. Upon input of the query, the product of the filters 48 and 49 with the corresponding composite color histogram 41 is computed for each indexed image, which results in two peaks 50 and 51. A score for ranking the image is obtained as the sum of the integrals (areas) of peaks 50 and 51. It is obviously assumed in the schematic representation of FIG. 5, that the level of Hue all along the portion 42 of the composite color histogram matches the level of Hue along the true color scale 16 and that the level of Brightness all along the portion 43 of the composite color histogram matches the level of Brightness along the gray color scale 15.

In the retrieval step 25, the images are retrieved from the database 8, starting with the highest ranking score and going down. In the image display step 26, as shown in FIG. 4, the retrieved images 37 and corresponding titles 38 are displayed in a list ranked in accordance with the ranking scores. Thus, the images having the largest proportion of the colors selected in the query are displayed at the head of the list. A normal slider bar 54 serves to scroll up and down the list.

The user interface screen 30 may include a selector, for example in the form of a potentiometer (not shown), for varying the length of the cursors 46 and 47 and for varying the width of the filters 48 and 49 accordingly. Thus, a user may define a level of selectivity of the query.

According to a further modification, the user interface screens 30 and 40 can be integrated into a single user interface screen by providing an ON/OFF switch (not shown) for the secondary composite color slider bar 45, which will cause the computer system to switch from a mode of operation corresponding to the first embodiment of the search method to a mode of operation corresponding to the second embodiment of the search method.

In the second embodiment described above, a hierarchy exists among the composite color slider bars 44 and 45, since more weight has been given to filter 48 than to filter 49. In an alternative embodiment, equal weights may be used so that both composite color slider bars 44 and 45 are given a totally equivalent function.

In theory, the cursor 46 or 47 may be positioned so as to overlap on both the gray color scale and the true color scale of the composite slider bar. Although the corresponding query can be treated by splitting it into a query pertaining to Hue and a query pertaining to Brightness, such a query makes little sense. Thus, it may be preferred to prohibit such overlapping positions for the two cursors, so that the cursor will jump the boundary between the color scales and move abruptly from an end position on the true color scale 16 to an end position on the gray color scale 15.

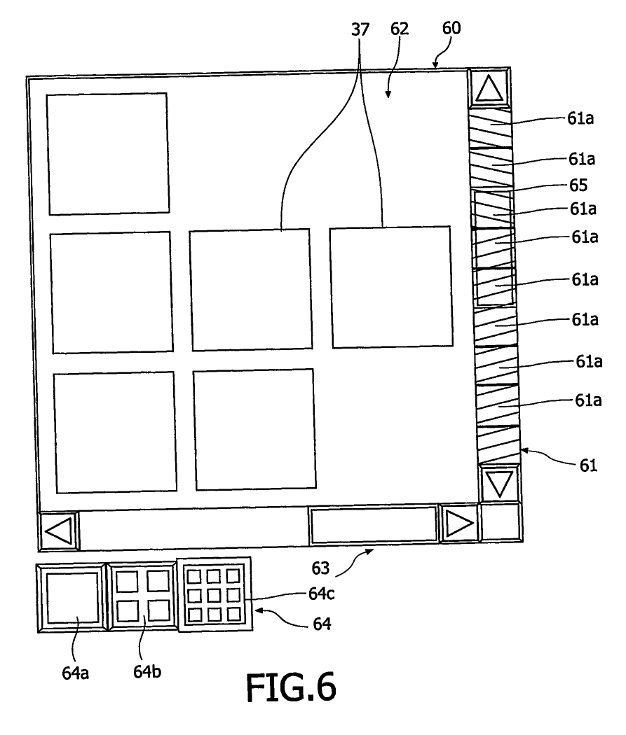

A third embodiment of the search method will be described below with reference to FIG. 6. In the image analysis step 21, the image analyzer 12 analyzes each image in accordance with the fourth embodiment of the indexation method, so that the indexation data of each image defines a predominant segment of Hue or Brightness corresponding to a generic type of color and matching the highest proportion of pixels in the image.

In the image sorting step 22, each image is sorted into a category corresponding to a generic type of color.

The user interface screen 60 includes a vertical segmented composite color slider bar 61 on one side, an image display area 62, a horizontal slider bar 63 to scroll through the retrieved images 37, and a view selector 64 for selecting the number of rows and columns to be simultaneously displayed.

The segmented composite color slider bar 61 comprises a colored key 61a for each of the above-mentioned generic colors. The color of the key 61 is set so as to provide a clear identification of the category. In FIG. 6, the order of the keys from top to bottom corresponds to the order of Table 1. However, if a category is empty, the corresponding colored key may be suppressed.

In the query input step 24, a cursor 65 is moved vertically in order to select a key 61a or a set of adjacent keys 61a, depending on the state of the view selector 64. When moved, for example with help of the pointing device 4, the cursor 65 can only jump to discrete positions corresponding to the keys 61a. In the retrieval step 25, each selected key 61a operates as a filter, so that the images which have been sorted into the corresponding category are retrieved and displayed in a row. Within each row, the images may be sorted in a number of manners, for example randomly or according to the exact proportion of pixels in the predominant segment, or according to other parameters. For example, radio buttons (not shown) may be included in the user interface screen 60 for the user to select a sorting parameter. The corresponding indexation data, which is needed to sort the images within a row, should preferably be gathered during the image analysis step 21, so that no substantial computations will be needed at the time of the retrieval.

The view selector 64 has three radio buttons. In FIG. 6, buttons 64c is actuated, so that three rows of images are displayed simultaneously, with up to nine images. In that case, the cursor 65 has a length of three keys. An actuation of button 64a causes the computer system to display one image at a time. In that case, the cursor 65 is resized to a length of one key. The horizontal slider bar 63 enables the user to scroll through the row of images 37. An actuation of button 64b causes the computer system to display up to four images at a time in two rows. In that case, the cursor 65 is resized to a length of two keys. Since the categories are predefined, each row may comprise a different number of images. Thus, empty spaces may exist at the end of some rows. The images of a selected category may also be displayed in columns instead of rows.

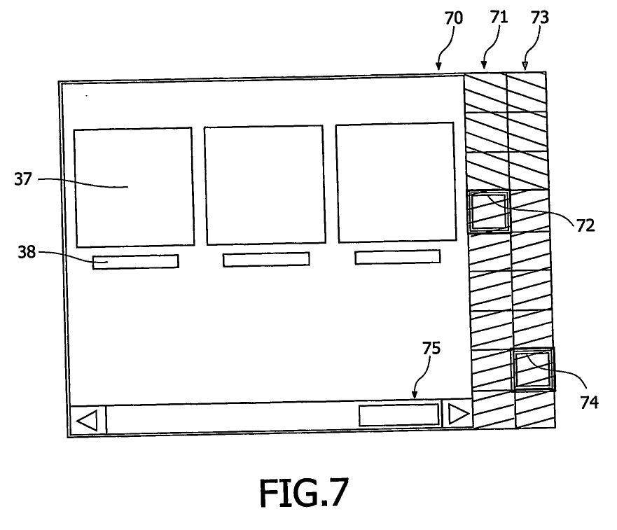

A fourth embodiment of the search method will be described below with reference to FIG. 7. The fourth embodiment combines features of the second and third embodiments of the search method. The image analysis step 21 is carried out in accordance with the third embodiment of the indexation method, so as to obtain a segmented composite color histogram similar to that shown n FIG. 10 as indexation data for each image. The sorting step 22 is omitted.

The user interface screen 70 includes two vertical segmented composite color slider bars similar to the segmented composite color slider bar 61 of the third embodiment: the segmented composite color slider bar 71 has colored keys 71a and a cursor 72 which is sized so as to select one category at a time, and the segmented composite color slider bar 73 has colored keys 73a and a cursor 74 which is sized so as to selec one category at a time.

In the query input step 24, a query is input on the basis of the positions of the two cursors 72 and 74. Each cursor operates as a running filter in a similar way as in the second embodiment of the search method. A ranking score of each image is computed in the same way as in that embodiment. The main difference between the two embodiments is that the composite color histogram of an image now corresponds to a predefined coarse segmentation of the Brightness and Hue spectrums and that the cursors 72 and 74 have a small number of predefined positions corresponding to this segmentation. Hence, the filters which result from the different positions allowed for the cursors 72 and 74 are predefined., and, the product of the segmented composite color histogram of an image by each possible filter can be computed and integrated in advance. Then, the computation of the scores for ranking which correspond to a given query will require very little computation, namely a sum of two partial scores per image. A horizontal slider bar 75 enables one to scroll through the retrieved images 37. The corresponding titles 38 are displayed under the images 37.

If the query consists in a double selection of the same category, the query may be interpreted in a specific manner, in order to focus on images in which that category is really predominant. For example, only those images are retriever wherein any other category gathers less than 5% of the pixels.

In an embodiment, the cover images 37 may have a link to a corresponding audio or video file in database 8, so that a double-click on a retrieved image will launch an audio or video software application and play the corresponding file.

The composite color slider bars of the above embodiments may be combined with other tools for searching images. For example, button-operated filters may be provided in the user interface screen in order to:

retrieve only images which have a high number of colors or a small number of colors, so as to distinguish photographs from artistic pictures,

retrieve only images which contain a specific object specified by a template, such as a musical instrument or a human face. Various shape recognition methods may be used for that purpose. The above list of filters is by no means limitative. When other searching tools are used, the indexation data of each image should be completed with the corresponding data such as, for example, a flag indicating the presence of a given object, etc.

The use of the verb “to comprise” or “to include” and its conjugations does not exclude the presence of elements or steps other than those stated in a claim. Furthermore, the use of the article “a” or “an” preceding an element or step does not exclude the presence of a plurality of such elements or steps. The invention may be implemented by means of hardware as well as software. Several “means” may be represented by the same item of hardware.

In the claims, any reference signs placed between parenthesis shall not be construed as limiting the scope of the claims.

1. An indexation method for indexing a graphic element, comprising the steps of:
determining a color attribute of the graphic element by providing a set of coordinates in a multidimensional color space (80) for at least one color of the color attribute,
reducing the set of coordinates of said at least one color to a level of Hue if said at least one color verifies a first condition,
reducing the set of coordinates of said at least one color to a level of Brightness if said at least one color verifies a second condition,
storing indexation data (13) for indexing said graphic element, said indexation data including a level of Hue resulting from said at least one color of the color attribute and/or a level of Brightness resulting from said at least one color of the color attribute.

2. An indexation method as claimed in claim 1, wherein said first condition is verified if the color belongs to a first predefined region (81) of the color space and said second condition is verified if the color belongs to a second predefined region (82) of the color space.

3. An indexation method as claimed in claim 2, wherein said first region of the color space is bounded by at least one of a lower bound of Saturation (83), a lower bound of Brightness (84), and an upper bound of Brightness (85).

4. An indexation method as claimed in claim 1, wherein said color attribute is a statistical distribution of colors in the graphic element, and wherein the indexation data (86, 89) includes a level of Hue and/or a level of Brightness resulting from each of a number of pixels in the graphic element.

5. An indexation method as claimed in claim 1, further comprising the step of sorting each said level of Hue in the indexation data in accordance with a predefined segmentation of a spectrum of Hue (87) and each said level of Brightness in the indexation data in accordance with a predefined segmentation of a spectrum of Brightness (88).

6. An indexation method as claimed in claim 1, wherein a collection of graphic elements (8) are indexed and said color attribute includes a single color for each graphic element of the collection, said indexation method further comprising the step of generating a collection index with the indexation data of the graphic elements, so as to sort the graphic elements into two subsets in accordance with whether said single color verifies said first or second condition and to order the graphic elements in each subset in accordance with whether a level of Hue or Brightness results from said single color.

7. A search method for searching a collection of graphic elements, comprising the steps of:
indexing (21, 22) each graphic element of the collection by an indexation method as claimed in claim 1,
receiving (24) at least one input specifying at least one desired color, determining a search query corresponding to said at least one input, said search query pertaining to a level or range of Hue if said at least one desired color includes a true color and to a level or range of Brightness if said at least one desired color includes a gray color,
analyzing (25) the indexation data of the graphic elements for selecting graphic elements whose indexation data comprises at least one level of Hue or Brightness substantially matching the search query, and
retrieving the selected graphic elements from the collection.

8. A search method as claimed in claim 7, further comprising the steps of:
generating (23) and displaying at least one composite color scale (31, 44, 45, 61, 71, 73) including a true color scale (32, 16) divided into colored portions (32a, 61a) having true colors corresponding to respective levels or ranges of Hue and a gray color scale (33, 15) divided into colored portions (33a, 61a) having gray colors corresponding to respective levels or ranges of Brightness,
generating and displaying a marker (34, 46, 47, 65, 72, 74) which can be moved on said composite color scale for receiving an input, wherein a corresponding desired color is specified in accordance with a position of said marker on said composite color scale.

9. A search method as claimed in claim 8, wherein said colored portions (61a) of the composite color scale (61) correspond to predefined ranges of Hue or Brightness, said marker (65) being allowed to move to discrete positions along the composite color scale, said positions being offset from one another by one colored portion each time.

10. A search method as claimed in claim 8, wherein said color attribute includes a single color and said indexation data includes a level of Hue or Brightness resulting from said single color for each graphic element of the collection, and wherein the colored portions (32a, 33a) of the composite color scale (31) are designed so as to obtain a substantially even density of matching graphic elements for all positions of the marker (34) along the composite color scale (31).

11. An indexation apparatus (1) for indexing a graphic element, comprising:
a color analyzer (12) for determining a color attribute of the graphic element by providing a set of coordinates in a multidimensional color space (80) for at least one color of the color attribute, for reducing the set of coordinates of said at least one color to a level of Hue if said at least one color verifies a first condition, and for reducing the set of coordinates of said at least one color to a level of Brightness if said at least one color verifies a second condition,
storage means (6, 7) for storing indexation data (13) for indexing said graphic element, said indexation data including a level of Hue resulting from said at least one color of the color attribute and/or a level of Brightness resulting from said at least one color of the color attribute.

12. A search apparatus (1) for searching a collection of graphic elements (8), comprising:
an indexation apparatus as claimed in claim 11 for indexing each graphic element of the collection,
a user-operable input means (11, 4, 5) for receiving at least one input specifying at least one desired color and for determining a search query corresponding to said at least one input, said search query pertaining to a level or range of Hue if said at least one desired color includes a true color and to a level or range of Brightness if said at least one desired color includes a gray color,
a graphic element retrieval controller (10) for analyzing the indexation data (13) of the graphic elements so as to select graphic elements whose indexation data comprises at least one level of Hue or Brightness substantially matching the search query, and for retrieving the selected graphic elements from the collection.

13. A search apparatus as claimed in claim 12, further comprising:
a composite color scale generation means (11) for generating a composite color scale (31, 44, 45, 61, 71, 73) displayable on a display unit (3), said composite color scale including a true color scale (32, 16) divided into colored portions (32a, 61a) having true colors corresponding to respective levels or ranges of Hue and a gray color scale (33, 15) divided into colored portions (33a, 61a) having gray colors corresponding to respective levels or ranges of Brightness,
a marker generation means (11) for generating a marker (34, 46, 47, 65, 72, 74) which is displayable on a display unit and can be moved on said composite color scale for receiving an input,
wherein a corresponding desired color is specified in accordance with a position of said marker on said composite color scale.

14. A consumer electronic product involving data storage and comprising a search apparatus as claimed in claim 12.
